(19) United States
(12) Patent Application Publication
(10) Pub. No.: US 2013/0091263 A1
(43) Pub. Date: Apr. 11, 2013

(54) METHOD AND APPARATUS FOR MANAGING APPLICATION PROGRAMS OF TERMINALS, METHOD AND APPARATUS FOR MANAGING APPLICATION PROGRAMS IN TERMINAL

(71) Applicants: Hye Won SONG, Daejeon (KR); Eun Jeong Choi, Daejeon (KR); Chang Seok Bae, Daejeon (KR); Jeun Woo Lee, Daejeon (KR)

(72) Inventors: Hye Won SONG, Daejeon (KR); Eun Jeong Choi, Daejeon (KR); Chang Seok Bae, Daejeon (KR); Jeun Woo Lee, Daejeon (KR)

(73) Assignee: ELECTRONICS AND TELECOMMUNICATIONS RESEARCH INSTITUTE, Daejeon (KR)

(21) Appl. No.: 13/606,133

(22) Filed: Sep. 7, 2012

(30) Foreign Application Priority Data
Oct. 10, 2011 (KR) 10-2011-0103252

(51) Int. Cl. G06F 15/173; G06F 9/44

(52) U.S. Cl. 709/223

(57) ABSTRACT

Disclosed is a method of managing application programs of terminals, including: receiving a synchronization request message according to change of an application program from a first terminal of a user; updating application program information stored in connection with the first terminal of the user in accordance with the change of the application program; and transmitting a notice message notifying the change of the application program to a second terminal of the user.

### CROSS-REFERENCE TO RELATED APPLICATIONS

This application claims priority to and the benefit of Korean Patent Application No. 10-2011-0103252 filed in the Korean Intellectual Property Office on Oct. 10, 2011, the entire contents of which are incorporated herein by reference.

### TECHNICAL FIELD

The present invention relates to a technology for synchronizing application programs of multiple terminals in a personal cloud environment, and to a method and an apparatus for managing application programs of terminals, and a method and an apparatus for managing application programs in a terminal.

### BACKGROUND ART

Recently, a user may access the same contents through a synchronization service for various contents, such as personal information, files, and email, at a network available place through a user's terminal in a cloud environment. For example, when a personal schedule is registered, updated, or deleted through a portable terminal, synchronization for the changed schedule is automatically progressed, so that the changed schedule may also be identified with another terminal, such as a desktop computer or a tablet PC.

In the same manner, when a picture, music, or multimedia contents, such as a video file, is added or removed through a specific terminal, the corresponding changed matter may also be identically applied through another terminal.

Many researches on data synchronization between multiple terminals have been conducted, but research on the synchronization of application programs installed in the terminals is insufficient. When the application programs between current terminals are desired to be synchronized, a user is required to directly install the application program in each terminal. Especially, in a case of heterogeneous terminals, a user is required to directly search for, select, and install an application program appropriate for a corresponding terminal or a platform of a terminal, so as to use the same application program.

### SUMMARY OF THE INVENTION

The present invention has been made in an effort to provide a method and an apparatus for managing application programs of terminals which is capable of effectively synchronizing application programs in various terminals of a user, and a method and an apparatus for managing application programs in a terminal.

An exemplary embodiment of the present invention provides a method of managing application programs of terminals, including: receiving a synchronization request message according to change of an application program from a first terminal of a user; updating application program information stored in connection with the first terminal of the user in accordance with the change of the application program; and transmitting a notice message notifying the change of the application program to a second terminal of the user.

The change of the application program may correspond to installation of a new application program, deletion of a pre-installed application program, or change of setting information on a pre-installed application program.

The application program information stored in connection with the first terminal may include a list of application programs installed in the first terminal.

The method of managing the application programs may further include, when the change of the application program corresponds to installation of a new application program, searching for a terminal in which the new application program can be installed in the terminals of the user, except for the first terminal, wherein the second terminal may correspond to a discovered terminal.

The searching for the terminal may include searching for a terminal, which has a different platform from that of the first terminal and in which the new application program having a different version from that of the new application program installed in the first terminal can be installed, in the terminals of the user, except for the first terminal.

The method of managing the application programs may further include, when the change of the application program corresponds to deletion of a pre-installed application program or change of setting information on a pre-installed application program, searching for a terminal in which the pre-installed application program is installed in the terminals of the user except for the first terminal, wherein the second terminal may correspond to a discovered terminal.

The transmitting of the notice message may include transmitting the notice message in a push scheme.

Another exemplary embodiment of the present invention provides a method of managing application programs in a terminal, the method including: when an application program is changed in a terminal of a user, transmitting a synchronization request message according to the change of the application program to an application program management server; receiving a notice message notifying change of an application program of another terminal of the user from the application program management server; and performing change of the application program in response to the notice message.

The application program management server may have application program information for each terminal of the user.

The receiving of the notice message may include receiving the notice message in a push scheme.

Yet another exemplary embodiment of the present invention provides an apparatus for managing application programs of terminals, including: an application program synchronization module for, when a synchronization request message according to change of an application program is received from a first terminal of a user, updating application program information stored in connection with the first terminal of the user in accordance with the change of the application program; and a change notification module for transmitting a notice message notifying the change of the application program to a second terminal of the user.

The apparatus for managing the application programs may further include a user terminal management module for, when the change of the application program corresponds to installation of a new application program, searching for a terminal in which the new application program can be installed in the terminals of the user, except for the first terminal, wherein the second terminal may correspond to a discovered terminal.

The user terminal management module may search for a terminal, which has a different platform from that of the first terminal and in which the new application program having a different version from that of the new application program installed in the first terminal can be installed, in the terminals of the user except for the first terminal.

The apparatus for managing the application programs may further include a user terminal management module for, when the change of the application program corresponds to deletion of a pre-installed application program or change of setting information on a pre-installed application program, searching for a terminal, in which the pre-installed application program is installed, in the terminals of the user except for the first terminal, wherein the second terminal may correspond to a discovered terminal.

The notice message may be transmitted in a push scheme.

Still another exemplary embodiment of the present invention provides an apparatus for managing application programs in a terminal, including: a synchronization handler module for, when an application program is changed, transmitting a synchronization request message according to the change of the application program to an application program management server; and an application program handler module for, when a notice message notifying change of an application program of another terminal is received from the application program management server, performing change of the application program in accordance with the notice message.

According to exemplary embodiments of the present invention, it is possible to effectively synchronize the application programs in the various terminals of the user. It is also possible to synchronize the application programs between terminals having the different platforms.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a network construction of a personal cloud environment according to an exemplary embodiment of the present invention.

FIG. 2 is a flowchart illustrating a method of managing application programs of terminals according to an exemplary embodiment of the present invention.

FIG. 3 is a flowchart illustrating a method of managing application programs in a terminal of a user according to an exemplary embodiment of the present invention.

FIG. 4 is a diagram illustrating a construction of an application program management server 200 that is an apparatus for managing application programs of terminals and an application program managing apparatus installed in a terminal 400.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although the exemplary embodiment of the present invention are described hereafter, the spirit of the present invention is not limited thereto and may be changed and modified in various ways by those skilled in the art.

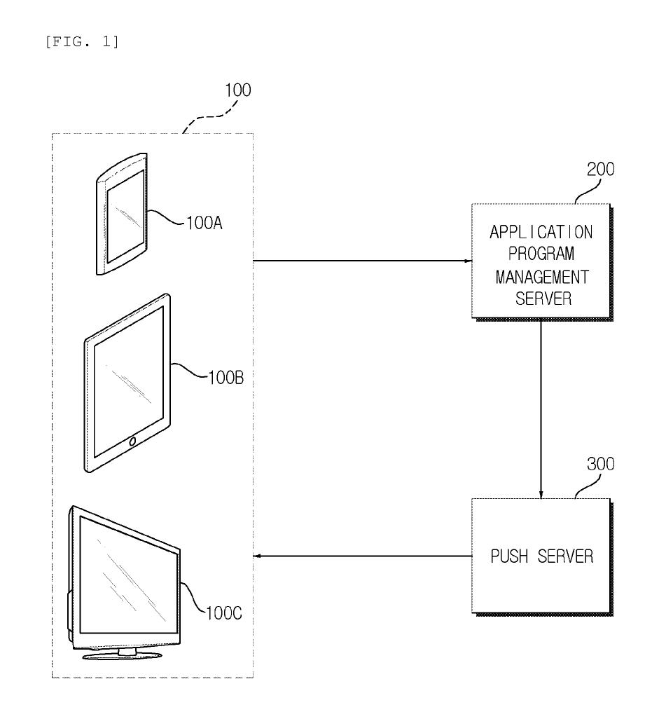

FIG. 1 illustrates a network construction of a personal cloud environment according to an exemplary embodiment of the present invention.

A user owns multiple terminals 100, and the terminals may be heterogeneous terminals, such as a smart phone 100A, a tablet PC 100B, and a smart TV 100C.

An application program management server 200 manages respective terminals and application programs installed in the respective terminals. The respective terminals of the user are registered in the application program management server 200 through a network in an initiation process. The application program management server 200 maintains application program information on the respective terminals of the user. The application program information contains various information on each application program including a list of application programs installed in each terminal, a version and authority of each application program, etc., and setting information on each application program.

When an application program of a specific terminal, for example, the smart phone 100A, among the terminals of the user, is changed, the corresponding terminal transmits a synchronization request message according to the change of the application program to the application program management server 200. The change of the application program may correspond to installation of a new application program, deletion of a pre-installed application program, or change of setting information on an installed specific application program.

The application program management server 200 receiving the synchronization request message updates application program information on the corresponding terminal. That is, when the application program is installed, the application program management server 200 adds the new application program to a list of the application programs, and when the application program is deleted, the application program management server 200 deletes the corresponding application program from the list of the application programs. When the setting information on the specific application program is changed, the application program management server 200 updates the setting information on the corresponding application program of the corresponding terminal.

Then, the application program management server 200 makes a request that a push server 300 transmits a notice message notifying another terminal, for example, the tablet PC 100B or the smart TV 100C, to which the change of the application program may be applied, of the change of the application program. The push server 300 transmits the notice message notifying the change of the application program to the tablet PC 100B or the smart TV 100C in a push scheme according to the request.

Depending on an exemplary embodiment, the push server 300 does not transmit the notice message notifying the change of the application program as described above, but the application program management server 200 may transmit the notice message notifying the change of the application program to the terminal without the push server 300.

The tablet PC 100B or the smart TV 100C receives the notice message, and performs the change of the application program identically to the smart phone 100A of which the application program is changed by communication with the application program management server 200 automatically or a selection of the user. That is, when the new application program is installed in the smart phone 100a, the tablet PC 100B or the smart TV 100C also installs the same application program, and when the specific application program is deleted in the smart phone 100A, the tablet PC 100B or the smart TV 100C also deletes the corresponding application program. When the setting information on the specific application program installed in the smart phone 100A is changed, the tablet PC 100B or the smart TV 100C also identically changes the setting information on the corresponding application program.

The tablet PC 100B or the smart TV 100C completing the change of the application program transmits the synchronization request message according to the change of the application program, and the application program management server 200 updates the application program information of the corresponding terminal.

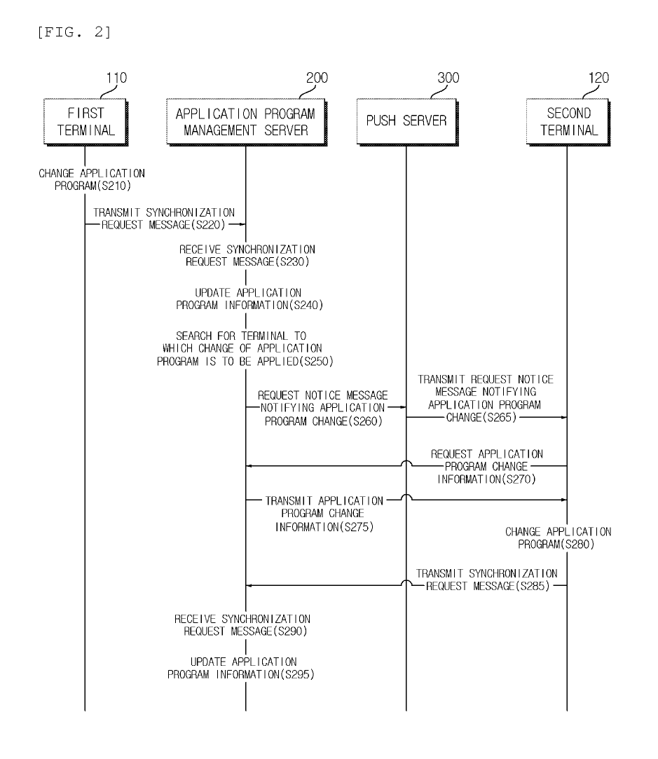

FIG. 2 is a flowchart illustrating a method of managing application programs of terminals according to an exemplary embodiment of the present invention.

An application program of a first terminal 110, which is one of the terminals owned by a user, is changed (S210). The change of the application occurs when the user installs a new application program or deletes a pre-installed application program in the first terminal 110, or when setting information on a specific application program pre-installed in the first terminal 110 is changed.

Here, the change of the setting information on the application program includes change of environment configuration of the application program, change of local data related to execution of the application program, etc. Here, the change of the environment configuration may correspond to configuring or changing a game environment to be appropriate to the user in a case of, for example, a game application program. The local data means additionally recordable data corresponding to the user of the application program while the application program is being executed. For example, the change of the local data of the application program may correspond to generation or change of score record generated while the game application program is being executed.

As described above, when the application program is changed, the first terminal 110 notifies the application program management server 200 of the change of the application program and transmits a synchronization request message requesting the synchronization according to the change of the application program (S220). The synchronization request message may include identification information on the user, identification information on the terminal, and a changed matter of the application program (identification information, version information, etc., on the corresponding application program when the application program is installed or deleted, identification information, version information, changed contents, etc., of the corresponding application program when the setting information on the application program is changed, etc.).

The application program management server 200 receives the synchronization request message transmitted by the first terminal 110 (S230).

The application program management server 200 identifies the user and the terminal transmitting the synchronization request message by interpreting the synchronization request message, and updates application program information stored in connection with the corresponding terminal in accordance with the changed matter of the application program included in the synchronization request message (S240). For example, when the new application program is installed in the first terminal 110, the application program management server 200 adds the corresponding application program to a list of application programs having application program information stored in connection with the first terminal 110 based on the identification information on the installed application program included in the synchronization request message. As another example, when the specific application program is deleted in the first terminal 110, the application program management server 200 deletes the corresponding application program from a list of application programs having application program information stored in connection with the first terminal 110 based on the identification information on the deleted application program included in the synchronization request message. As another example, when the setting information on the specific application program installed in the first terminal 110 is changed, the application program management server 200 changes setting information on the corresponding application program included in application program information stored in connection with the first terminal 110 based on identification information and changed contents of the application program included in the synchronization request message. The application program management server 200 searches for a terminal to which the change of the application program is to be applied identically to the first terminal 110 in the terminals of the user, except for the first terminal 110 (S250). As described above, the application program management server 200 includes information on the respective terminals of the user. The information on the terminal contains a model, identification information, hardware information, platform (operating system) information, etc., on the terminal. The application program management server 200 maintains information related to the installation of various application programs. The information related to the installation contains version information, installable hardware specification or platform, authority information, etc. The application program management server 200 searches for the terminal, to which the change of the application program is to be applied, in the terminals of the user based on the information on the respective terminals and the information related to the installation of the application program.

For example, when the change of the application program corresponds to installation of the new application program, the application program management server 200 searches for a terminal in which the corresponding application program may be installed based on the information on the respective terminals of the user and the information related to the installation of the application program. A terminal having the hardware specification and the platform demanded in the corresponding application program may be discovered as the terminal to which the corresponding application program may be installed.

In the meantime, even the same application program may have various versions and each version may demand the use of different hardware and platforms. Accordingly, even if a terminal has a platform different from that of the first terminal 110, but the application program having a version different from that of the application program installed in the first terminal 110 may be installed in the terminal, the application program management server 200 also inserts the terminal in a result of the search.

When the change of the application program corresponds to the deletion of the pre-installed application program, the application program management server 200 searches for a terminal in which the corresponding application program is installed based on the list of the application programs.

When the change of the application program corresponds to the change of the setting information on the application program installed in the terminal, the application program management server 200 searches for a terminal in which the corresponding application program is installed based on the list of the application programs.

When a second terminal 120 that is the terminal, to which the change of the application program is to be applied, is discovered, the application program management server 200 makes a request for transmission of a notice message notifying the second terminal 120 of the change of the application program to the push server 300 (S260). Then, the push server 300 transmits the notice message notifying the change of the application program to the second terminal 120 in a push scheme (S265). As described above, depending on the exemplary embodiment, the application program management server 200 may directly transmit the notice message notifying the change of the application program to the second terminal 120 in the push scheme without the push server 300.

The second terminal 120 receiving the notice message makes a request for application program change information to the application program management server 200 automatically or according to a selection of the user regarding whether to change the application program (S270). The application program change information may contain identification information and version information on the application program to be installed or deleted, or identification information, version information, changed contents of the setting information, etc., on the application program of which the setting information is changed. The application program management server 200 receiving the request for the application program change information transmits the application program change information to the second terminal 120 (S275).

According to the exemplary embodiment, the application program management server 200 may simultaneously transmit the application program change information while transmitting the notice message notifying the change of the application program. In this case, the process S270 of making the request for the application program change information and the process S275 of transmitting the application program change information may be omitted.

The second terminal 120 receiving the application program change information performs the change of the application program based on the application program change information (S280). When the application program change information corresponds to “the installation of the application program”, the second terminal 120 installs the corresponding application program. When the application program change information corresponds to “the deletion of the application program”, the second terminal 120 deletes the corresponding application program. When the application program change information corresponds to “the change of the setting information on the application program”, the second terminal 120 changes the setting information on the corresponding application program.

When the change of the application program is completed, the second terminal 120 transmits a synchronization request message according to the change of the application program to the application program management server 200 (S285). The application program management server 200 receives the synchronization request message (S290), and updates the application program information stored in connection with the second terminal 120 (S295). For example, when the new application program is installed in the second terminal 120, the application program management server 200 adds the corresponding application program to a list of application programs having application program information stored in connection with the second terminal 120 based on the identification information on the installed application program included in the synchronization request message. As another example, when the specific application program is deleted in the second terminal 120, the application program management server 200 deletes the corresponding application program in a list of application programs having application program information stored in connection with the second terminal 120 based on the identification information on the deleted application program included in the synchronization request message. As another example, when the setting information on the specific application program of the second terminal 120 is changed, the application program management server 200 changes setting information on the corresponding application program included in application program information stored in connection with the second terminal 120 based on the identification information and the changed contents of the setting information on the application program included in the synchronization request message.

It is necessary to discriminate the synchronization request message (in S285) which the second terminal 120 transmits to the application management server 200 after performing the change of the application program in response to the notice message notifying the change of the application program from the synchronization request message (in S220) which the first terminal 110 transmits to the application management server 200 after autonomously performing the change of the application program. This is because when the application program management server 200 updates the application program information by receiving the synchronization request message (in S285) from the second terminal 120, it is not necessary to notify another terminal of the change of the application program. Accordingly, information indicating “the change of the application program in response to the notice message” may be inserted in the synchronization request message (in S285) transmitted to the application management server 200 after the change of the application program in response to the notice message.

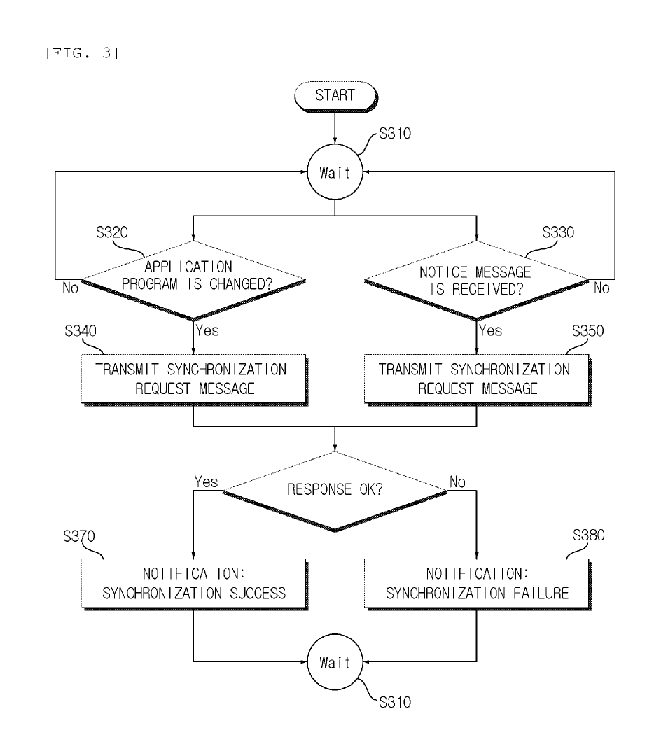

FIG. 3 is a flowchart illustrating a method of managing application programs in a terminal of a user according to an exemplary embodiment of the present invention. An apparatus for managing the application programs may be installed in the terminal, and the method of managing the application programs according to the exemplary embodiment of the present invention corresponds to a process of the application program managing apparatus installed in the terminal.

The application program managing apparatus normally maintains in a standby state (S310).

When change of the application program is generated in a terminal (S320), the application program managing apparatus transmits a synchronization request message according to the change of the application program to the application program management server 200 (S340). The change of the application program may correspond to installation of a new application program, deletion of a pre-installed application program, or change of setting information on an installed specific application program.

When the terminal receives a notice message notifying the change of an application program of another terminal of the user from the application program management server 200 (S330), the application program managing apparatus performs the change of the application program by communicating with the application program management server 200 (S350). That is, the application program managing apparatus makes a request for application program change information to the application program management server 200, receives the application program change information from the application program management server 200, and then installs or deletes the corresponding application program based on the received application program change information or changes setting information on the corresponding application program.

The application program management server 200 transmits a response (for example, an http response) to the synchronization request message (in S340) or the communication for the change (S350) of the application program to the terminal (S360). When the response of the application program management server 200 is normal, the application program managing apparatus outputs a message indicating synchronization success to the user through the terminal (S370). When the response of the application program management server 200 is not normal, the application program managing apparatus outputs a message indicating synchronization failure to the user through the terminal (S380).

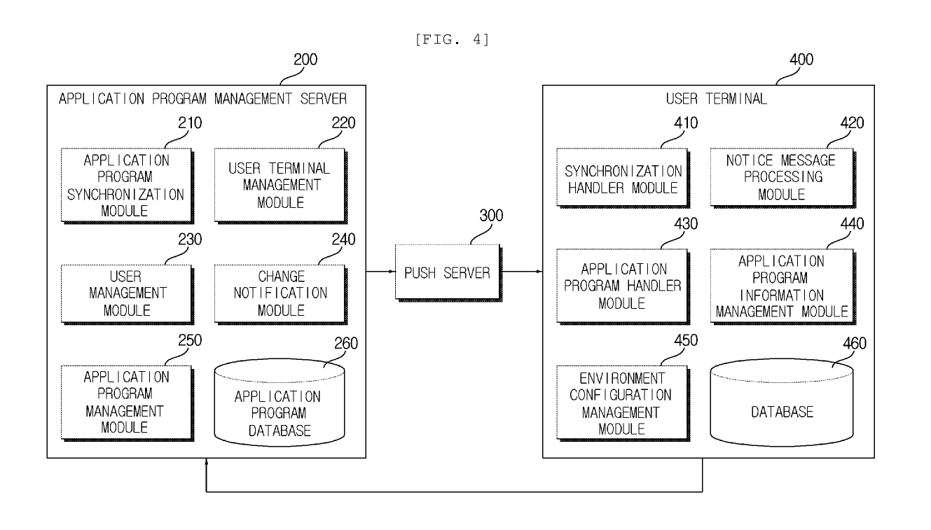

FIG. 4 is a diagram illustrating a construction of the application program management server 200 that is the apparatus for managing application programs of the terminals and the application program managing apparatus installed in a terminal 400.

The application program management server 200 includes an application program synchronization module 210, a user terminal management module 220, a user management module 230, a change notification module 240, an application program management module 250, and an application program database 260.

When the application program synchronization module 210 receives a synchronization request message from the terminal, the application program synchronization module 210 identifies the user and the terminal transmitting the synchronization request message by interpreting the synchronization request message, and updates stored application program information stored in connection with the corresponding terminal in accordance with a changed matter of the application program included in the synchronization request message. For example, when a new application program is installed in the terminal transmitting the synchronization request message, the application program synchronization module 210 adds the corresponding application program to a list of application programs having the application program information stored in connection with the corresponding terminal based on identification information on the installed application program included in the synchronization request message. As another example, when a specific application program is deleted in the terminal transmitting the synchronization request message, the application program synchronization module 210 deletes the corresponding application program from a list of application programs having the application program information stored in connection with the corresponding terminal based on identification information on the deleted application program included in the synchronization request message. As another example, when setting information on a specific application program is changed in the terminal transmitting the synchronization request message, the application program synchronization module 210 changes the setting information on the corresponding application program included in the application program information stored in connection with the corresponding terminal based on identification information and changed contents of setting information on the corresponding application program included in the synchronization request message.

The user terminal management module 220 manages information on respective terminals of users for each user. The information on the terminal contains a model, identification information, hardware information, platform (operating system) information, etc., on the terminal as described above.

The user terminal management module 220 also searches for a terminal to which the change of the application program is to be applied in the terminals of the corresponding user, except for the terminal transmitting the synchronization request message, based on the information on each terminal.

For example, when the change of the application program corresponds to installation of the new application program, the user terminal management module 220 searches for a terminal in which the corresponding application program may be installed based on the information on each terminal and information related to the installation of the application program. Even if one terminal has a platform different from that of the terminal transmitting the synchronization request message, but if the application program having a version different from that of the application program installed in the terminal transmitting the synchronization request message may be installed in the one terminal, the user terminal management module 220 also inserts the one terminal in a result of the search.

When the change of the application program corresponds to deletion of the pre-installed application program, the user terminal management module 220 searches for a terminal in which the corresponding application program is installed based on the list of application programs of the corresponding user.

When the change of the application program corresponds to the change of the setting information on the specific application program, the user terminal management module 220 searches for a terminal in which the corresponding application program is installed based on the list of application programs of the corresponding user.

When the terminal to which the change of the application program is to be applied is discovered by the user terminal management module 220, the change notification module 240 requests the push server 300 to transmit a notice message notifying the change of the application program to the discovered terminal. Then, the push server 300 transmits the notice message notifying the change of the application program to the discovered terminal in a push scheme. Depending on an exemplary embodiment, the change notification module 240 may directly transmit the notice message notifying the change of the application program to the terminal in the push scheme without the push server 300.

The user management module 230 manages information on users registered in the application program management server 200.

The application program management module 250 manages information related to the installation of various application programs. The information related to the installation contains version information, installable hardware specification or platform, authority information, etc.

The application program database 260 stores the information related to the installation of the various application programs, information on the registered users, information on the respective terminals of the users for each user, and application program information connected with each terminal.

The application program managing apparatus installed in the terminal includes a synchronization handler module 410, a notice message processing module 420, an application program handler module 430, an application program information management module 440, an environment configuration management module 450, and a database 460.

When the change of the application program is generated in the terminal, the synchronization handler module 410 transmits the synchronization request message according to the change of the application program to the application program management server 200. The change of the application program may correspond to the installation of a new application program, the deletion of a pre-installed application program, or the change of setting information on an installed specific application program as described above.

The notice message processing module 420 processes the notice message which notifies the change of an application program of another terminal and is received from the application program management server 200.

When the application program handler module 430 receives the notice message, the application program handler module 430 performs the change of the application program by communication with the application program management server 200. That is, the application program handler module 430 makes a request for application program change information to the application program management server 200, receives the application program change information from the application program management server 200, and then installs or deletes the corresponding application program or changes the setting information on the application program based on the received application program change information.

The application program information management module 440 manages information on an application program installed in the terminal. The information contains a list of installed application programs and setting information on respective application programs. When the application program is installed or deleted, the application program information management module 440 updates the list of the application programs, and when the setting information on the application program is changed, the application program information management module 440 updates the setting information on the corresponding application program.

The environment configuration management module 450 manages environment configuration information on the application program managing apparatus. For example, the environment configuration management module 450 includes information on whether to receive the notice message transmitted by the application program management server 200, information on whether to perform the change of the application program automatically or according to a selection of the user when the notice message is received, an account for a push service, etc.

The database 460 stores the environment configuration information on the application program managing apparatus and information, such as information on the application programs installed in the terminal, managed by the application program managing apparatus.

Meanwhile, the exemplary embodiments according to the present invention may be implemented in the form of programs that can be executed by computers, and may be implemented in a general-use digital computer for operating the program by using a computer readable recording media. The computer readable media may include storage medium, such as a magnetic storage medium (for example, ROM, floppy disk, and hard disk) and an optical reading medium (for example, CD-ROM and DVD).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of managing application programs of terminals, comprising:
receiving a synchronization request message according to change of an application program from a first terminal of a user;
updating application program information stored in connection with the first terminal of the user in accordance with the change of the application program; and
transmitting a notice message notifying the change of the application program to a second terminal of the user.

2. The method of claim 1, wherein the change of the application program corresponds to installation of a new application program, deletion of a pre-installed application program, or change of setting information on a pre-installed application program.

3. The method of claim 1, wherein the application program information stored in connection with the first terminal includes a list of application programs installed in the first terminal.

4. The method of claim 1, further comprising:
when the change of the application program corresponds to installation of a new application program, searching for a terminal in which the new application program can be installed in the terminals of the user, except for the first terminal, wherein the second terminal corresponds to a discovered terminal.

5. The method of claim 4, wherein the searching for the terminal comprises searching for a terminal, which has a different platform from that of the first terminal and in which the new application program having a different version from that of the new application program installed in the first terminal can be installed, in the terminals of the user except for the first terminal.

6. The method of claim 1, further comprising:
when the change of the application program corresponds to deletion of a pre-installed application program or change of setting information on a pre-installed application program, searching for a terminal in which the pre-installed application program is installed in the terminals of the user except for the first terminal, wherein the second terminal corresponds to a discovered terminal.

7. The method of claim 1, wherein the transmitting of the notice message comprises transmitting the notice message in a push scheme.

8. A method of managing application programs in a terminal, the method comprising:
when an application program is changed in a terminal of a user, transmitting a synchronization request message according to the change of the application program to an application program management server;
receiving a notice message notifying change of an application program of another terminal of the user from the application program management server; and
performing change of the application program in response to the notice message.

9. The method of claim 8, wherein the change of the application program corresponds to installation of a new application program, deletion of a pre-installed application program, or change of setting information on a pre-installed application program.

10. The method of claim 8, wherein the application program management server has application program information for each terminal of the user.

11. The method of claim 8, wherein the receiving of the notice message comprises receiving the notice message in a push scheme.

12. An apparatus for managing application programs of terminals, comprising:
an application program synchronization module for, when a synchronization request message according to change of an application program is received from a first terminal of a user, updating application program information stored in connection with the first terminal of the user in accordance with the change of the application program; and
a change notification module for transmitting a notice message notifying the change of the application program to a second terminal of the user.

13. The apparatus as claimed in claim 12, wherein the change of the application program corresponds to installation of a new application program, deletion of a pre-installed application program, or change of setting information on a pre-installed application program.

14. The apparatus as claimed in claim 12, wherein the application program information stored in connection with the first terminal includes a list of application programs installed in the first terminal.

15. The apparatus as claimed in claim 12, further comprising:
a user terminal management module for, when the change of the application program corresponds to installation of a new application program, searching for a terminal in which the new application program can be installed in the terminals of the user, except for the first terminal, wherein the second terminal corresponds to a discovered terminal.

16. The apparatus as claimed in claim 15, wherein the user terminal management module searches for a terminal, which has a different platform from that of the first terminal and in which the new application program having a different version from that of the new application program installed in the first terminal can be installed, in the terminals of the user except for the first terminal.

17. The apparatus as claimed in claim 12, further comprising:
a user terminal management module for, when the change of the application program corresponds to deletion of a pre-installed application program or change of setting information on a pre-installed application program, searching for a terminal, in which the pre-installed application program is installed, in the terminals of the user except for the first terminal, wherein the second terminal corresponds to a discovered terminal.

18. The apparatus as claimed in claim 12, wherein the notice message is transmitted in a push scheme.

19. An apparatus for managing application programs in a terminal, comprising:
a synchronization handler module for, when an application program is changed, transmitting a synchronization request message according to the change of the application program to an application program management server; and
an application program handler module for, when a notice message notifying change of an application program of another terminal is received from the application program management server, performing change of the application program in accordance with the notice message.

20. The apparatus of claim 19, wherein the change of the application program corresponds to installation of a new application program, deletion of a pre-installed application program, or change of setting information on a pre-installed application program.
